(19) United States
(12) Patent Application Publication
(10) Pub. No.: US 2008/0072604 A1
(43) Pub. Date: Mar. 27, 2008

(54) Pressure balance control for gas turbine engine nozzle

(75) Inventors: Timothy A. Swanson, Coventry, CT (US); Debora F. Kehret, Manchester, CT (US); Stefan M. Poth, South Windsor, CT (US); Donald E. Grove, East Hartford, CT (US)

Correspondence Address: CARLSON, GASKEY & OLDS/PRATT & WHITNEY, 400 WEST MAPLE ROAD, SUITE 350, BIRMINGHAM, MI, 48009, US

(73) Assignee: United Technologies Corporation

(21) Appl. No.: 11/527,188

(22) Filed: Sep. 26, 2006

(51) Int. Cl. F02K 1/00

(52) U.S. Cl. 60/770

(57) ABSTRACT

A balance pressure control is provided for flaps which pivot in a rear of a gas turbine engine nozzle to change the cross-sectional area of the nozzle. An actuator drives a sync ring to move the flaps through a linkage. A supply of pressurized air is also provided to the sync ring to assist the actuator in resisting forces from high pressure gases within the nozzle. When those forces are lower than normal the flow of air to the rear of the sync ring is reduced or blocked.

This invention was made with government support under U.S. Navy Contract No. N00019-02-C-3003. The government therefore has certain rights in this invention.

### BACKGROUND OF THE INVENTION

This application relates to a control for air pressure supplied to assist in balancing forces on a linkage for controlling a nozzle cross-sectional area in a gas turbine engine.

A gas turbine engine includes a fan section, a compression section, a combustion section and a turbine section. An axis of the engine is centrally disposed along the engine and extends longitudinally through the sections. A primary flow path for working medium gases extends axially through the sections of the engine.

The nozzle for the gas turbine engine may be provided with an actuation structure that can cause a plurality of flaps to pivot radially inwardly or outwardly to control the size of the nozzle opening. In the prior art, a hydraulic actuator drives a ring which is connected through linkages to the plurality of flaps. A control causes the actuator to move the flaps between various positions to provide a desired cross-sectional area.

In the prior art, it is also known to supply air pressure to a rear face of the ring to assist in handling a load on the actuation structure. In part, this load is created since there is relatively high engine air pressure within the nozzle, and acting on an inner surface of the flaps, and relatively low ambient temperature on an outer surface of the flaps. The high pressure supplied to the rear face of the ring assists in carrying some of this load. However, at times, the ratio between the pressure within the nozzle and the ambient pressure is much lower. As an example, at low speed/low altitude applications the ratio is typically low. In such applications there may be too much air pressure supplied to the ring. This is undesirable as it causes excessive load to be imparted on the actuation system.

### SUMMARY OF THE INVENTION

In the disclosed embodiment of this invention, a control modulates the flow of pressurized air to the rear face of the ring based upon sensed system conditions. As an example, a pressure sensor may sense the pressure within the nozzle and the ambient pressure, and limit or block the flow of pressurized air to the ring when this ratio is relatively low. In one disclosed embodiment, should the ratio of engine pressure to ambient pressure be less than three, then the flow of pressurized air to the ring is reduced or eliminated. The control may be based upon a local controller, by the overall engine controller, or may be controlled simply by a pressure responsive valve acting upon the difference in pressure.

These and other features of the present invention can be best understood from the following specification and drawings, the following of which is a brief description.

### BRIEF DESCRIPTION OF THE DRAWINGS

FIG. 1A shows a prior art gas turbine engine.

FIG. 1B shows one portion of a convergent-divergent axisymmetric nozzle for the gas turbine engine.

FIG. 2 shows the inventive structure.

### DETAILED DESCRIPTION OF THE PREFERRED EMBODIMENT

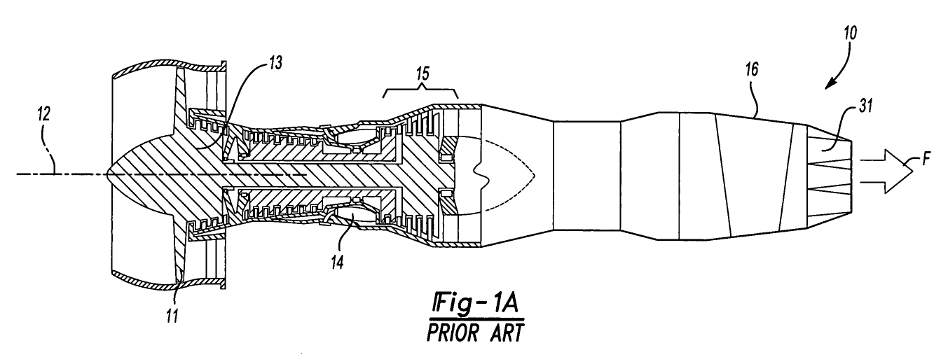

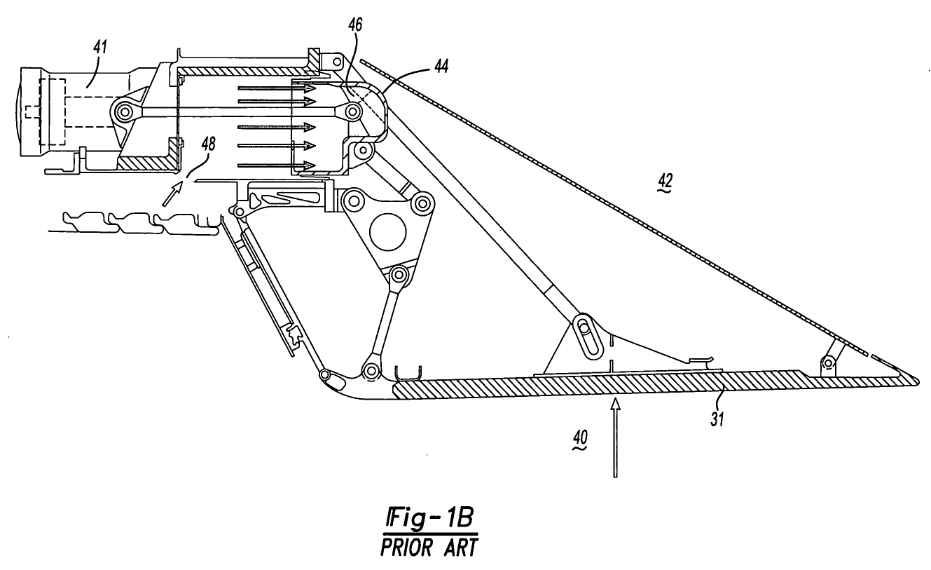

FIG. 1A shows a gas turbine engine 10. As known, a fan section 11 moves air and rotates about an axial center line 12. A compressor section 13, a combustion section 14, and a turbine section 15 are also centered on the axial center line 12. A nozzle section 16 of the turbine discharges gas downstream. FIG. 1A is a highly schematic view, however, it does show the main components of the gas turbine engine. Further, while a particular type of gas turbine engine is illustrated in this figure, it should be understood that the present invention extends to other types of gas turbine engines.

As also shown in FIG. 1A, a plurality of flaps 31 at the end of the nozzle 16 can be pivoted radially inwardly or outwardly to control the cross-sectional area at the nozzle. This is as known in the art, and an actuation structure for pivoting the flaps 31 is shown in FIG. 1B. As shown, a hydraulic actuator 41 drives a sync ring 44 through a connection at 46. Air pressure 40 within the nozzle acts on an inner surface of the flaps 31, while an ambient pressure 42 outside the flaps 31 acts on an outer surface of the flaps 31. Typically, the air pressure at 40 is much greater than the ambient air pressure 42. This imbalance creates forces on the sync ring 44. Thus, pressurized air is delivered through openings 48 to the rear surface of the sync ring 44 to assist in handling the load.

At times, however, the pressure ratio between the areas 40 and 42 will be lower. This occurs, for example, at low altitude/low speed flying. In such instances, the force supplied through the openings 48 through the pressurized air on the rear surface of the sync ring 44 can be unduly high and can itself create undesirable loads and stresses on the various connections.

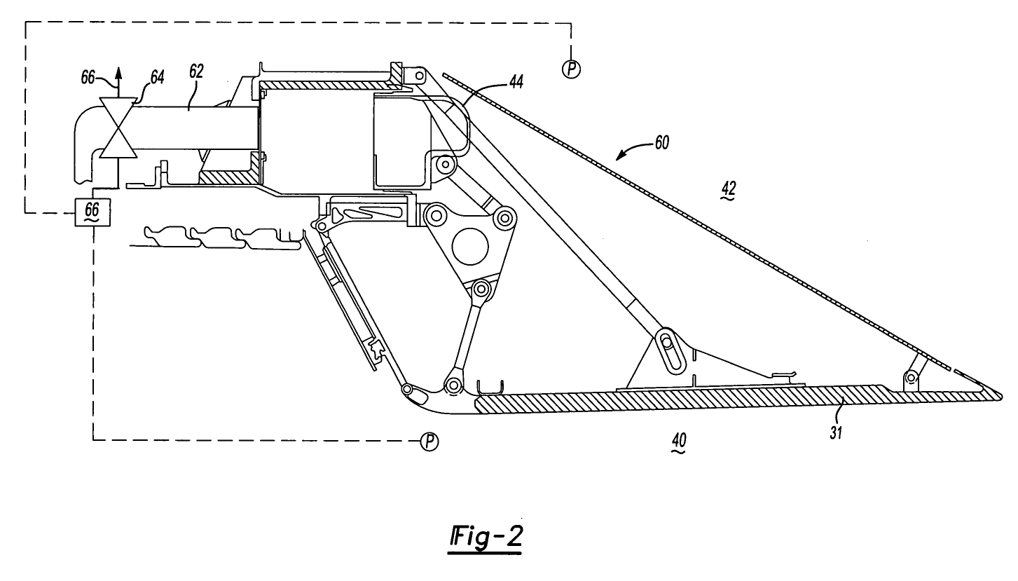

Thus, as shown in FIG. 2, in an inventive nozzle control 60, an air supply tube 62 is provided with a valve 64, and which is controlled by a control 66. Control 66 may trigger the valve 64 either through a simple delta pressure control based upon the pressures at 40 and 42, or the control can be based upon an electronic control. In one application, it may be the controller for the entire engine. Essentially, should the pressure ratio between areas 40 and 42 be lower (e.g., less than three), then it would be desirable to block airflow to the sync ring 44, and instead open the cavity to a lower pressure source (e.g., atmosphere) as shown at 66. Notably, the hydraulic actuator 41 is omitted from the view but would preferably be included.

In this manner, the higher pressure forces on the sync ring 44 at certain conditions are lowered to atmospheric pressure or less.

A preferred and more detailed valve is disclosed in concurrently filed U.S. patent application Ser. No. ______, entitled “Combined Control for Supplying Cooling Air and Support Air in a Turbine Engine Nozzle.”

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A nozzle for a gas turbine engine comprising:
a plurality of flaps which may move to provide a desired cross-sectional area for a nozzle outlet;
an actuator structure for driving said flaps through a linkage, said actuator structure including at least one actuator member moving the flaps through an intermediate structure; and
an air supply for supplying pressurized air to a surface of said intermediate structure, said pressurized air assisting said actuator member in holding said flaps at a desired position, and resisting a force from pressure within said nozzle, and a valve for controlling flow of pressurized air to said surface of said intermediate member, a control for said valve reducing the flow of air when certain system conditions are sensed.

2. The nozzle as set forth in claim 1, wherein a pressure ratio between the air pressure within said nozzle, and an ambient pressure is utilized to control said valve.

3. The nozzle as set forth in claim 2, wherein the flow of pressurized air to said rear surface is reduced when said ratio is less than three.

4. The nozzle as set forth in claim 1, wherein said intermediate member is a sync ring defining a chamber for receiving pressurized air, and being connected to said actuator member.

5. The nozzle as set forth in claim 4, wherein said actuator member is a fluid actuator.

6. The nozzle as set forth in claim 1, wherein said control is a pressure difference actuated valve.

7. The nozzle as set forth in claim 1, wherein said control is part of an overall control for a gas turbine engine.

8. The nozzle as set forth in claim 1, wherein said valve dumps air to atmosphere when the flow of air to the intermediate member is to be reduced.

9. A method of operating a gas turbine engine comprising the steps of:
(1) providing an actuator structure for driving flaps through a linkage to provide a desired cross-sectional area for a nozzle outlet, said actuator structure including at least one actuator member moving the flaps through an intermediate structure; and
(2) supplying pressurized air to a surface of said intermediate structure, said pressurized air assisting said actuator in holding said flap at a desired position, and resisting a force from pressure within said nozzle, and reducing flow of pressurized air to said surface of said intermediate member when certain system conditions are sensed.

10. The method as set forth in claim 9, wherein a pressure ratio between the air pressure within said nozzle, and an ambient pressure is the sensed system condition.

11. The method as set forth in claim 10, wherein the flow of pressurized air to said rear surface is reduced when said ratio is less than three.

12. The method as set forth in claim 9, wherein said intermediate member is a sync ring defining a chamber for receiving pressurized air, and being connected to said actuator.

13. The method as set forth in claim 12, wherein said actuator member is a fluid actuator.
